(19) United States
(12) Patent Application Publication
(10) Pub. No.: US 2007/0295448 A1
(43) Pub. Date: Dec. 27, 2007

(54) SYSTEM FOR FORMING LEAF LAMINATES

(76) Inventor: Ishwar R. Mansukhani, Neenah, WI (US)

Correspondence Address: BOYLE FREDRICKSON S.C., 840 North Plankinton Avenue, MILWAUKEE, WI, 53203, US

(21) Appl. No.: 11/767,285

(22) Filed: Jun. 22, 2007

Related U.S. Application Data
(60) Provisional application No. 60/815,936, filed on Jun. 23, 2006.

(51) Int. Cl. B44C 1/14

(52) U.S. Cl. 156/277

(57) ABSTRACT

A method of forming a laminate including a very thin leaf layer. In a first step an image corresponding to a desired pattern is printed in a conventional manner on said substrate using an ink having adhesive properties. The substrate and image are then covered with a very thin, frangible leaf material such a very thin metal foil. The leaf material is then laminated onto said image by applying pressure to said leaf, image and substrate. Mechanical agitation is then used to remove excess leaf outside the boundaries of the image by flaking off the excess leaf from the substrate.

### CROSS-REFERENCE TO RELATED APPLICATIONS

This application claims the benefit of and priority from U.S. Provisional Patent Application 60/815,936 filed Jun. 23, 2006, which is incorporated herein by reference.

### BACKGROUND OF THE INVENTION

The present invention relates to applying leaf such as metal leaf to substrates to form laminates comprising useful articles such as RF antennas.

Applying precious metal leaf onto decorative objects commonly known as gilding is an ancient art. Gilding has traditionally involved applying a thin layer of adhesive material to an object and after the adhesive becomes slightly tacky fitting a very thin and frangible metal leaf onto the surface. A small amount of physical pressure is applied over the surface of the object and the leaf along the surface onto which the leaf is intended to be placed. Excess leaf is then brushed away. Beautiful objects of art can be formed by this process. This invention endeavors to make an ancient technique available to an on-demand world.

Thin metal layers made from metal foils are frequently used in electrical circuit boards and may be formed into complex patterns for electrical conductors and circuits such as radio frequency RF antennas. However, in these cases the metal layers are made by photo-etching as is common in the electrical and semiconductor industries. Such photo-etching involves depositing a photoresist material on a foil, exposing and developing the photoresist material in a desired pattern and then chemically etching away the unwanted foil material to leave the desired construction.

For example, U.S. Pat. No. 6,421,013 to Chung describes a wireless article with a loop antenna. The antenna is formed from a metal foil on one side of a substrate by photo-etching and is attached to an electronic device. The article is constructed and reinforced through the use of strong dielectric adhesives to form durable items such as a tamper-resistant RF tags.

Circuit board elements are frequently made from specially prepared metal foils. U.S. Pat. No. 5,989,727 to Yates describes the treatment of cooper foils intended for subsequent use in the fabrication of copper-clad laminates in printed circuit boards (PCBs). One side of the copper foil is treated by being micro-roughened with an electrodeposited dendritic copper layer and two “gilding” layers to improve the bonding of the foil to polymeric substrates used in circuit boards. The later layers are not really gilded in accordance with traditional definitions of the term but are instead electrodeposited. Yates also refers to prior art techniques for roughening metal foils including mechanical abrasion and chemical etching. However, such foils are ultimately intended to be formed into electrical components by application of photo-etching.

U.S. Pat. No. 6,701,605 to Huffer et al describes a method of printing electrical elements such as RFID antennas using a special coatings and inks. First, a circuit pattern is applied to a substrate using a coating featuring a surface tension lowering additive. An electrically conductive ink is then applied over the coating. The ink flows away from the coating forming elements shaped by the pattern of the coating.

Alternatively, the application of metal foils as decorative elements is described in a number of patents. For example, U.S. Pat. No. 6,223,799 to Johnstone and its parent case U.S. Pat. No. 5,520,763 describe systems for fabricating artistic articles using metal foil layers as well as U.S. Pat. Nos. 4,484,970 to Burzlaff et al, 4,724,026 to Nelson, 4,053,344 to Hirahara and 3,519,512 to Downs. However, the systems described in these patents use a special adhesive or sizing layer on the metal foil to adhere the foil to a substrate and appear to employ foils having a relatively thick gauge that are usually cut to shape prior to application and the processes for removal of excess foil are not fully disclosed.

The patents to Johnstone are related to your invention but use a foil strip with a carrier film or backing, a release coating, a foil and then a transfer adhesive (see 24 in FIG. 2). Toner on substrate is heated to make it receptive to the adhesive on the foil. In end product includes the substrate, toner, adhesive and foil (see FIG. 4). The removal of the excess foil is not described although it appears travels on to the take-up roll on the backing.

The patent to Burzlaff et al is interesting in that ink is used for printed material that includes a release agent. A metal foil having a thermoplastic adhesive layer is brought into pressure contact with tube (i.e. substrate) and heat is applied to adhere the foil to the surface of the substrate. The metal foil is described as rupturing at the juncture of the printed matter and tube to leave the printed matter free from foil but the manner in which this is achieved is not disclosed.

The patent to Hirahara seems to involve using an ink on a moulded article having proper tackiness which is brought into contact with a stamping foil having adhesive on one side which reacts and adheres to the ink but not the article. Pressure and heat are used to affix the foil to the article. The foil remains on the printing.

The patent to Downs describes the application of “roll leaf” including metallic in gold and silver colors. However, the roll leaf has multiple layers including plastic film, lacquer, vacuum-deposited aluminum and an adhesive or sizing layer. A “sensitized layer” which may be ink is deposited in a pattern on an article and then partially dried. The sensitizers are chosen to be compatible with the adhesive or sizing on the roll leaf. Heat and pressure are used to affix the leaf along the pattern of the sensitized layer on the article.

### SUMMARY OF THE INVENTION

The present invention comprises a system for fabricating laminates including very thin frangible metal leaf layers. In a first step an image or pattern is printed on a substrate such as a paper sheet using an ink having adhesive properties. Many conventional types of ink contain sufficient resin to provide the required adhesive properties for adhering frangible leaf materials. The ink is allowed to partially dry and become tacky. The area containing the image is then covered by a very thin frangible generally metal leaf of a metal such as silver, copper, aluminum or gold and the leaf is brought into contact with the ink comprising the printed image. A controlled amount of pressure is then applied to help the metal leaf adhere to the image in order to properly laminate the leaf and substrate together. Additionally, a limited amount of heat may be usefully employed to assist the lamination process. In appropriate cases heat can also be used to reactivate the adhesive properties of many dried resinous inks. After the bond between the leaf and printed image has set, the excess leaf can be removed. Accordingly, The excess metal leaf outside the boundaries of the image is removed by being mechanically agitated or abraded by processes such as gentle brushing or scrubbing with a fluid medium which easily flake off the leaf that is not adhered to the substrate on account of its highly frangible nature.

A material is considered frangible for this process if the force required to tear the material is less than the binding force present between the material, the printed image, and the printing substrate. A tearing force is applied through bending, elongation, or any other mode whose primary axis of action is not into the material. The term friable is used interchangeably with frangible.

Conventional types of ink in general do not contain sufficient resin to act as an adhesive. The resin loads required to act as an adhesive would in general prevent inks from having properties needed to work effectively in modern printing environments. Due to the low tearing force needed with frangible leafs many conventionally formulated types of ink can, and do, provide sufficient adhesion to be used with this invention, and are able to operate in modern printing environments.

The invention will remove excess material by applying a force sufficient to tear the portion of leaf that has not adhered to the print image from the remainder of the leaf, adhered to the print image. Unlike processes that require a tearing or cutting force to be applied along a particular direction or path, the tearing force may be applied in any direction and along any path. The force could also be applied in multiple directions, or along multiple paths concurrently.

An object of the present invention is to provide a system for manufacturing thin metal leaf laminates that is easier and more economical than methods previously employed.

It is another object of the present invention to provide a process for producing metal leaf laminates that is adapted for using existing printing equipment and printing technologies in a new way.

It is a further object of the present invention to provide a system for producing metal leaf laminates that are very flexible and will allow metal leafs to be applied to many different kinds of surfaces.

It is yet another object of the present invention to provide a system for producing a wide variety of laminated leaf articles having special electrical, magnetic, optical and catalytic properties including, for example, antennas for RFID tags, labels for use on articles of commerce including commodities such as fruit produce, logos for documents.

### BRIEF DESCRIPTION OF THE DRAWINGS

FIG. 1 is a flowchart illustrating the basic steps in accordance with the system of present invention.

FIG. 2 is a cross section of a laminate produced in accordance with the present invention.

### DETAILED DESCRIPTION

### Basic System

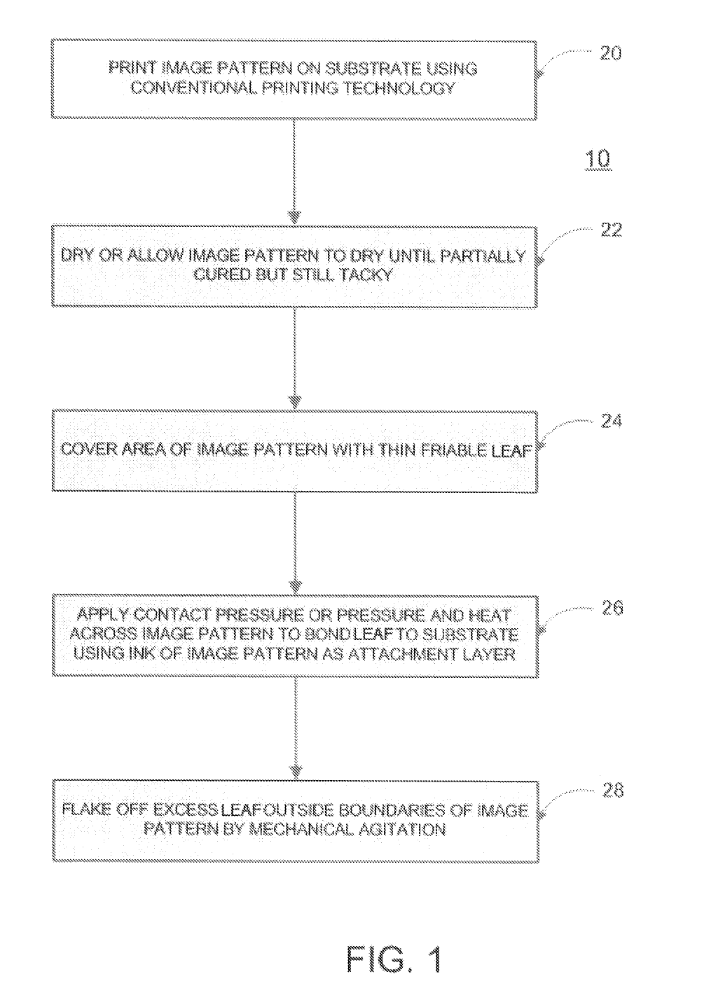

My invention provides a way of manufacturing laminated articles having printed patterns fabricated using frangible materials such as very thin friable metal leafs on almost any kind of substrate. Referring now to FIG. 1, the system 10 of my invention involves five basic steps:

As shown in step 20, an image is transferred onto a substrate, by any of a large number of well-known printing methods (contact or non contact). As shown in step 22, the image is then preferably allowed to dry, depending on the application, substrate, and ink until it is partially cured but still retains a substantial amount of tackiness, although the image may be allowed to fully dry if sufficient heat and pressure are later used to the reactivate adhesive components in the ink (e.g. soften resins and restore tackiness). As further shown in step 24, the image is covered with a thin metal film or leaf comprising a frangible material. As shown in step 26, the image and leaf are then laminated by the application of pressure and heat. As finally shown in step 28, the resulting laminated image and substrate are gently scrubbed by some mechanical method to remove the excess frangible material such as rotating or moving brushes, sponges or fluid flow provided by compressed air or water jets or vacuum pressure.

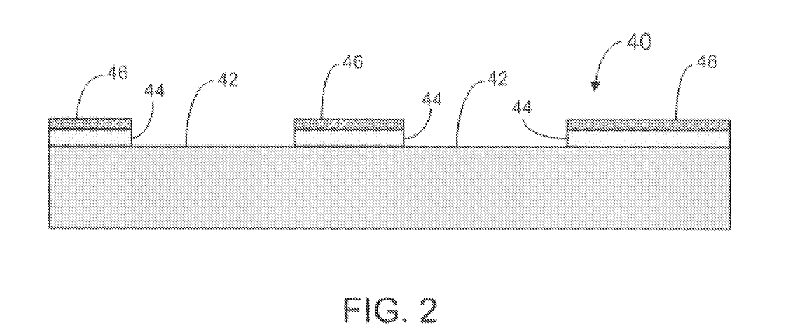

Referring now to FIG. 2, a laminate 40 produced in accordance with the present invention includes three layers: the substrate 42, the (printed) ink film 44 and the metal leaf 46.

The system 10 eliminates the need to use cutting tools to form or remove excess material, increases printing speeds compared to current methods such as electro-deposition of leaf or leaf like materials, and expands the types of substrates that leafs can be combined with.

Inks containing pigments and waxes, once dry, generally cannot be laminated with frangible leafs unless they are modified to contain adhesive components. This is because they contain a discontinuous resin film. However, inks based on dyes and without waxes can be softened, even if totally dry, by heating, and can bond continuously to frangible or flake-able materials. Laminating the printed image and leaf together at elevated temperatures and under pressure has the added advantage that frangible material not in contact with the image expands (along with the moisture present in paper and in air). Because the material cannot move sideways, this expansion causes it to move upwards, making the material flake off more easily. Further, after cooling, the laminated substrate and frangible material shrink together and reduce the size of any pinholes.

### System and Process Parameters

The substrate can be: any solid material (absorbent or non-absorbent) that can be exposed to direct or indirect pressure, heat or pressure and heat. The pressure applied will be in the general range 1 to 7 bar and is preferably applied for in general under a second. The heat the substrate will be exposed to should not exceed 450 Kelvin in general and will again be applied for under a second in most circumstances. Examples of possible substrates range from paper sheets as thin as airmail paper to as heavy as foam board, plastic sheets, metal sheets, food items (such as fruit), wood, stone (even marble or granite), etc.

The printing method can be: any mechanical way of printing (including non-contact) such as letterpress, planographic, flexographic, graveure, silk-screen, ink-jet, laser, or other equivalent printing methods.

The ink can be: an appropriate ink depending on the printing method and substrate used, however, inks containing substantial amounts of resinous materials or specially added adhesive components are preferred that provide sufficient tackiness for the leaf to quickly bond with the ink and substrate. Alternatively, special lamination inks containing components providing adhesive properties may be employed. Many resin based inks having conventional formulations have adequate adhesive properties.

The leaf can be: any of a number of frangible materials that are generally very thin such as metal leaf (preferably in the range of >0.21 μm but <8 μm). Leaf materials other than metals or metal alloys may be employed although very thin metal leaf made out of gold, silver, copper, palladium, or aluminum are preferred. For example, a 0.4 μm silver leaf is highly suitable. Other suitable leafs may include compositions including non-metallic materials that do not flake well at room temperature, but will flake away from substrates at lower temperatures.

The pressure can be: the pressure of the lamination will broadly vary depending on the specific application, ink, leaf, and substrate, but will generally use pressures in the range of those currently employed by commercially available lamination equipment, typically 1 to 7 bar.

The temperature can be: the temperature of the lamination will vary depending on specific application, but will be close to Ring and Ball softening point of the resin used in the ink or glue or for most such cases approximately 450 Kelvin.

The drying time can be: depending upon the substrate, ink, leaf, degree of the bond required and the thicknesses of the materials, the laminating time will range from a fraction of a second to more than 10 seconds.

Sample Ink Formulations

| Potential Ink | | | Amounts |
|---|---|---|---|
| System | Example | Ingredients | (g) |
| Ink-jet ink | A | Bleached & Dewaxed Shellac | 11.0 |
| | | (food grade) | |
| | | Ethanol | 22.0 |
| | | Butyrolactone | 158.0 |
| | | Morfast 108 Black | 12.0 |
| Ink-jet ink | B | Bleached & Dewaxed Shellac | 6.67 |
| | | (food grade) | |
| | | Ethanol | 13.33 |
| | | Normal Butanol | 50.0 |
| | | Tertiary Butanol | 50.0 |
| | | Isopropanol | 33.0 |
| | | Butyrolactone | 10.0 |
| | | Baso 124 yellow dye (BASF) | 7.0 |
| Flexo Ink | C | Nitrosol 250 LR (Aqualon) | 20.0 |
| | | Water | 200.0 |
| | | Triethanolamine | 5.0 |
| | | Propylene Glycol Mono Propylene | 5.0 |
| | | Ether | |
| | | Diacetone alcohol | 5.0 |
| | | Pontamine Yellow RB Liquid | 5.0 |
| Dry Offset | D | Pace 382 | 65.0 |
| | | Propylene Glycol | 5.0 |
| | | Thixotropic Varnish | 30.0 |

1. A method of forming a laminate including a leaf characterized by a pattern on a substrate, comprising the steps of:
a) printing an image corresponding to said pattern on said substrate using an ink having adhesive properties;
b) covering said substrate including said image with a thin frangible leaf;
c) laminating said leaf onto said image by applying pressure to said leaf, image and substrate; and
d) mechanically agitating said leaf in order to remove excess leaf outside the boundaries of the image by flaking the excess leaf off the substrate.

2. The method of claim 1, further including the steps of:
drying said image until said ink is substantially cured, and wherein:
said step of laminating also includes applying heat to said leaf and printed image.

3. The method of claim 1, further including the step of:
allowing said image to dry until said ink is partially cured but still retains substantial tackiness.

4. The method of claim 1, wherein:
said planar substrate comprises paper.

5. The method of claim 1, wherein:
said frangible leaf comprises a silver leaf of about 0.4 cm thickness.

6. The method of claim 5, wherein:
said ink includes resinous components providing adhesive properties.

7. The method of claim 1, wherein:
said frangible leaf comprises a aluminum leaf.

8. The method of claim 1, wherein:
said step of agitating includes using brushes to provide mechanical abrasion to said leaf.

9. The method of claim 7, wherein:
said step of agitating includes using compressed air to provide mechanical abrasion to said leaf.

10. The method of claim 1, wherein:
said step of printing is performed using an ink-jet printer.

11. The method of claim 1, wherein:
said step of printing is performed using a letterpress printer.

12. The method of claim 1, wherein:
said step of printing is performed using a planographic printer.

13. The method of claim 1, wherein:
said step of printing is performed using flexographic printer.

14. The method of claim 1, wherein:
said step of printing is performed using a silk-screen printing process.

15. A method of forming a laminate having a thin metal leaf layer in order to fabricate an electrical circuit or decorative element on the surface of the laminate, comprising the steps of:
a) printing a pattern for said circuit on a planar substrate using an ink having adhesive properties;
b) covering said substrate including said pattern with a thin frangible metal leaf;
c) laminating said metal leaf onto said pattern by applying pressure to said leaf, pattern and substrate; and
d) flaking the metal leaf off of said substrate outside of the boundaries of said pattern.

16. The method of claim 15, further including:
drying said pattern until said ink is substantially cured, and wherein:
said step of laminating also includes applying heat to said leaf and printed pattern.

17. The method of claim 15, wherein:
said planar substrate comprises paper.

18. The method of claim 15, wherein:
said planar substrate comprises a food item.

19. The method of claim 15, wherein:
said frangible leaf comprises a silver leaf.

20. The method of claim 15, wherein:
said frangible leaf comprises a copper leaf.

21. The method of claim 15, wherein:
said frangible leaf comprises aluminum leaf.

22. The method of claim 15, wherein:
said step of flaking includes using mechanical abrasion to remove said leaf outside the boundaries of said image.

23. The method of claim 22, wherein:
said step of flaking includes using a brush to provide said mechanical abrasion.

24. The method of claim 15, wherein:
said step of printing is performed using an ink-jet printer.

25. The method of claim 15, wherein:
said ink includes resinous materials providing adhesive properties.
